(19) United States
(12) Patent Application Publication
(10) Pub. No.: US 2002/0114924 A1
(43) Pub. Date: Aug. 22, 2002

(54) Decorative surfaces for architectural panels

(76) Inventor: Richard C. Albert, Landenberg, PA (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/072,133

(22) Filed: Feb. 7, 2002

Related U.S. Application Data
(60) Provisional application No. 60/269,246, filed on Feb. 16, 2001.

(51) Int. Cl. B32B 1/00

(52) U.S. Cl. 428/141

(57) ABSTRACT

A decorative architectural panel comprises a substrate, a base layer of fluoropolymer film adhered to the substrate and at least one discontinuous top layer of preformed fluoropolymer film that forms a decorative, textured surface. The fluoropolymer surfacing film protects the substrate while providing decorative features. Steel panels in accordance with the invention, resembling traditional asphalt construction materials, are especially useful for residential roofing.

### FIELD OF INVENTION

This invention relates to architectural panels having durable, decorative, textured surfaces.

### BACKGROUND OF THE INVENTION

Fluoropolymer films have long been used as a protective overlay for a variety of substrates such as metal, wood, and thermoplastic and thermoset polymers. With its excellent chemical resistance and weathering properties, a thin layer of fluoropolymer film can protect less durable substrates from damage in both exterior and interior use. In recent years, manufacturers of automobiles, recreational vehicles, sports craft and industrial and farm equipment have begun using decorative fluoropolymer film structures to surface selected parts of vehicles and equipment in lieu of paint. Single layer polymer film and multilayer polymer films have been used.

As steel panels become more popular for use in the building industry, there is interest in both providing protection to the metal substrate as well as creating a decorative surface. Fluoropolymer paint, such as paint composed of polyvinylidene fluoride or vinylidene fluoride copolymers, has previously served both functions and has been acceptable for the construction of industrial and commercial buildings. Because of the increased durability, a growing trend promotes the use of steel panels for residential roofing. Steel is lightweight and has wind resistance, fire resistance and is also resistant to damage caused by hail. In the residential roofing segment, in contrast to the industrial and commercial applications, there is a desire that the roofing material have a textured, earth color look that resembles traditional asphalt shingle and not the flat look of painted surfaces. In addition to aesthetics, a textured roofing panel is desirable in providing a slip resistant surface important to worker safety during construction and maintenance. In an effort to achieve the desired aesthetics, roofing materials have been offered wherein the steel panel is first painted and then small stones are glued to the surface. These multiple steps required for manufacture are time consuming and expensive.

A textured, decorative roofing panel surfaced with fluoropolymer film would be highly desirable. Fluoropolymer resins are known for their low surface energy and non-stick properties as well as thermal and chemical resistance. Fluoropolymer films can resist the ill effects of harsh chemical agents and allow for ease in cleaning. Further a fluoropolymer film construction would provide protection of the metal from corrosion due to weathering and because of the increased UV stability of fluoropolymer films, would reduce damage caused by exposure to sun. A fluoropolymer/steel laminate construction could be easily manufactured. However, the very properties that make fluoropolymer films desirable for outdoor use hinder the ability of fluoropolymer films to receive decorative images and difficult to permanently texture. There is a need for a fluoropolymer film construction that is both decorative and textured for application to metal substrates in the production of durable architectural panels.

### BRIEF SUMMARY OF THE INVENTION

The present invention relates to a decorative architectural panel having a substrate, a base layer of preformed fluoropolymer film adhered to the substrate and at least one discontinuous top layer of fluoropolymer that forms a textured surface. The fluoropolymer surfacing film protects the substrate while providing decorative features. In a preferred embodiment, the base layer of fluoropolymer film is pigmented with a first color or is clear and the discontinuous top layer is pigmented with a second color to form a decorative, textured surface with a speckled pattern.

The invention further relates to decorative sheeting for surfacing architectural panels having a base layer of preformed fluoropolymer film and at least one discontinuous top layer of fluoropolymer that forms a decorative, textured surface. A process for making the sheeting is also provided which includes forming a continuous pigmented base layer of preformed fluoropolymer film having a first color, applying at least one discontinuous pigmented top layer of fluoropolymer film having a second color to the base layer, and applying heat and pressure to fuse the top layer to the base layer to form decorative sheeting with a speckled pattern. Processes for forming architectural panels are also provided.

The present invention provides a durable, textured, decorative architectural panel protected by fluoropolymer film from the effects of weathering or other environmental attack. In its preferred embodiment, the panel is a decorated steel substrate. The panel of this invention aesthetically resembles traditional construction material while having the benefit of increased durability and the extended lifetimes of steel. Because of the textured nature of the panel it can be used as roofing material conferring slip resistance during periods of construction and maintenance. In addition, the fluoropolymer film surface of the roofing panel deters corrosion.

### BRIEF DESCRIPTION OF THE DRAWINGS

FIG. 1 is a side elevational view in enlarged cross-section of the textured, decorative surface sheeting of the invention.

FIG. 2 is a side elevational view in enlarged cross-section of an architectural panel with a textured, decorative surfacing film.

FIG. 3 is a schematic of a process for forming the textured, decorative surface sheeting of the invention using nip rolls to bond a discontinuous top layer of fluoropolymer film to a base layer of preformed fluoropolymer film.

FIG. 4 is a schematic of a process for forming the textured, decorative sheeting of the invention using a double belt press to bond a discontinuous top layer of fluoropolymer film to a base layer of fluoropolymer film.

FIG. 5 is an image showing a top view of typical decorative sheeting of this invention.

### DETAILED DESCRIPTION OF THE INVENTION

### Decorative Architectural Panel

The present invention provides for a decorative architectural panel having a substrate, a base layer of preformed fluoropolymer film adhered to the substrate and at least one discontinuous top layer of fluoropolymer that forms a textured surface. The base layer and the discontinuous top layer in combination will be referred to as decorative surface sheeting. With reference to the attached drawings, FIG. 1 illustrates decorative surface sheeting of the present invention generally indicated as 10 having a base layer 11 of preformed fluoropolymer film and a discontinuous top layer 12 of fluoropolymer film. In a preferred embodiment, the discontinuous top layer is made up of flakes 12a of fluoropolymer film. Of course many other ways for forming the discontinuous layer are acceptable. Such examples include applying globules of fluoropolymer paint onto the base layer and applying a preformed layer fluoropolymer film with discontinuities such as punched out holes. By “discontinuous”, it is meant, that the top layer does not fully cover the base layer. The discontinuous top layer has interruptions in the film surface providing contrast in texture and/or color between the base and top layers. The total thickness of the preferred decorative sheeting of this invention is from 0.5 mils (13 μm) to 12 mils (305 μm).

The flakes 12a, may be applied in any pattern, either ordered or random. The flakes may be densely or sparsely applied. The flakes may entirely contact the base layer or may overlap with other flakes comprising the top layer. In the most preferred embodiment, the fluoropolymer film in the base layer is of one color and the discontinuous top layer is of a second color forming a speckled pattern. An image representing the top view of a typical, decorative sheeting of this invention is shown in FIG. 5.

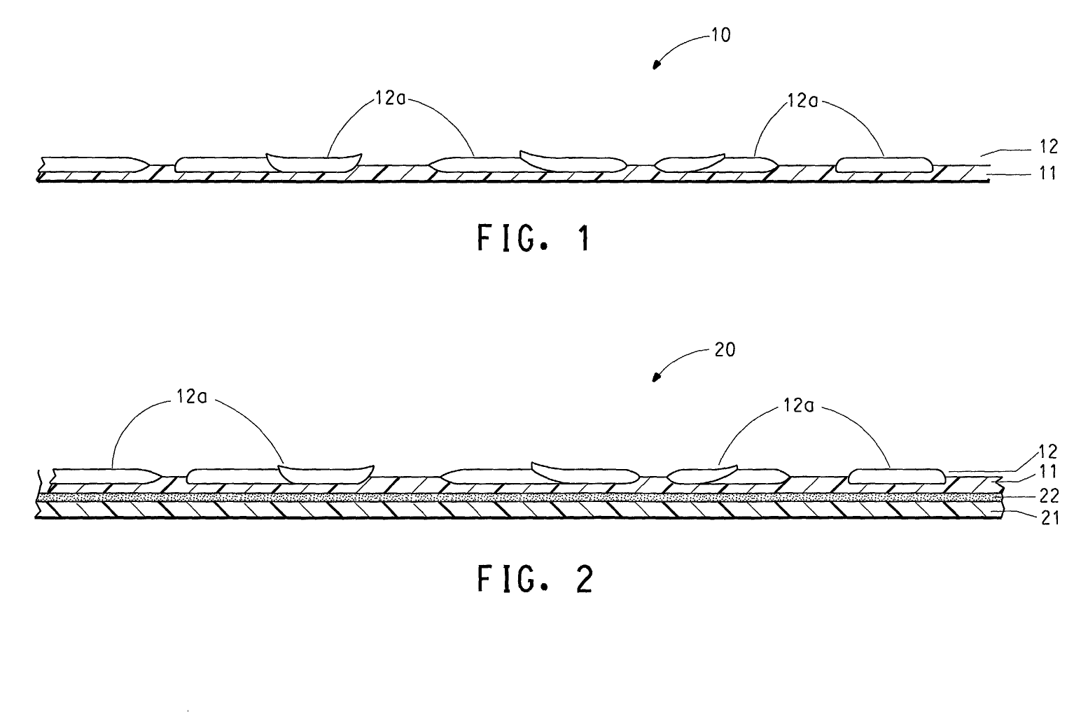

FIG. 2 illustrates a decorative architectural panel of the present invention generally indicated as 20 having a substrate 21, an adhesive layer 22, a base layer of preformed fluoropolymer film and a discontinuous top layer of fluoropolymer film. In the preferred form, the substrate is metal. Suitable metal substrates for use in this invention include steel, aluminum, iron, chromium, bronze, brass, lead, tin and nickel. Coated steels such as steel coated with zinc (i.e., galvanized steel) or zinc aluminum alloy are also suitable. Other suitable substrates include glass and other vitreous substrates such as porcelain and china; impregnated substrates such as asphalt-impregnated cellulosics; hardboards such as “Masonite”; cement-asbestos boards; and wood and plywood. In another preferred form of the invention, the substrate is a polymer. Suitable polymeric substrates include vinyl chloride polymers and copolymers and thermoplastic polyolefins, polyesters, nylon, and ABS. The total thickness of the preferred panel of this invention is from 10 mils (250 μm) to 42 mils (1070 μm). In the most preferred form the metal substrate is steel for use as metal roofing. In another embodiment, the decorated metal substrate is used for exterior wall panels. The preferred thickness of steel substrate for this use is in the range of 10 mils (250 μm) to 30 mils (765 μm).

More details as to the composition and formation of the fluoropolymer films that comprise the decorative surface sheeting and the architectural panel are explained below.

### Fluoropolymer Film

A wide range of fluoropolymers can be used for the fluoropolymer base layer as well as the discontinuous top layer of fluoropolymer. Such fluoropolymer films are those prepared from polymers and copolymers of trifluoroethylene, hexafluoropropylene, monochlorotrifluoroethylene, dichlorodifluoroethylene, tetrafluoroethylene, perfluorobutyl ethylene, perfluoro(alkyl vinyl ether), vinylidene fluoride, vinyl fluoride, among others and including blends thereof and blends of fluoropolymers with nonfluoropolymers. For example, the fluoropolymer may be a fluorinated ethylene/propylene copolymer, i.e., FEP resins, a copolymer of ethylene/tetrafluoroethylene, a copolymer of tetrafluoroethylene/perfluoro(propyl vinyl ether), a copolymer of ethylene/chlorotrifluoroethylene, vinylidene fluoride/hexafluoropropylene, and vinylidene fluoride/perfluoro (alkyl vinyl ether) dipolymers and terpolymers with tetrafluoroethylene, polyvinylidene fluoride homopolymer (PVDF), polyvinyl fluoride homopolymer (PVF), among others.

Fluoropolymer film, particularly polyvinyl fluoride, is especially useful for the practice of the invention because of its attractiveness. Such film possesses an unusual combination of excellent resistance to outdoor weathering exposures, a high degree of physical toughness, chemical inertness, abrasion resistance, resistance to soiling and the action of solvents as well as an significant retention of these properties at both low and elevated temperatures.

The present invention is preferably employed with polyvinyl fluoride (PVF) films. Other preferred films for use in the present invention are made from polyvinylidene fluoride (PVDF) or from a blend of fluoropolymer, e.g., PVDF and nonfluoropolymer, e.g., acrylic polymers.

The fluoropolymer film can be made from fluid compositions that are either (1) solutions or (2) dispersions of fluoropolymer. Films are formed from such solutions or dispersions of fluoropolymer by casting or extrusion processes. In the case of fluoropolymers that are melt processible, melt extrusion processes are possible. Both oriented and unoriented fluoropolymer films can be used in the practice of the present invention.

Typical solutions or dispersions for polyvinylidene fluoride or copolymers of vinylidene fluoride are prepared using solvents that have boiling points high enough to avoid bubble formation during the film forming/drying process. The polymer concentration in these solutions or dispersions is adjusted to achieve a workable viscosity of the solution and in general is less than about 25% by weight of the solution. A suitable fluoropolymer film is formed from a blend of polyvinylidene fluoride, or copolymers and terpolymers thereof, and acrylic resin as the principal components as described in U.S. Pat. Nos. 3,524,906; 4,931,324; and 5,707,697.

In the preferred form of the invention using preformed films of polyvinyl fluoride (PVF) for the fluoropolymer base layer, suitable films can be prepared from dispersions of the fluoropolymer. The nature and preparation of such dispersions are described in detail in U.S. Pat. Nos. 2,419,008; 2,510,783; and 2,599,300. Suitable PVF dispersions can be formed in, for example, propylene carbonate, N-methyl pyrrolidone, γ-butyrolactone, sulfolane, and dimethyl acetamide.

The base layer of the present invention can be clear or contain a pigment to produce film having a color. By clear it is meant that the polymer film is optically clear. Thus, the polymer film may be transparent or tinted with the image being visible therethrough.

In the preferred embodiment, a film of color is desired in which case one or more solid color pigments is added to the dispersion mixture. By solid color pigment is meant a pigment which when mixed with polymer produces a solid color layer which is not lustrous. For many architectural applications, solid, matte colors are preferred. Suitable pigments include carbon black, titanium dioxide, iron oxide, nickel titanate, quinacridone, copper phthalocyanine, cobalt aluminate, mixtures thereof, among others.

The PVF polymer and pigments are milled together, often with the help of a dispersing agent. A wide variety of mills can be used for the preparation of the dispersion. Typically, the mill employs a dense agitated grinding medium, such as sand, steel shot, glass beads, ceramic shot, Zirconia, or pebbles, as in a ball mill, an ATTRITOR® available from Union Process, Akron, Ohio, or an agitated media mill such as a “Netzsch” mill available from Netzsch, Inc., Exton, Pa. The dispersion is milled for a time sufficient to cause deagglomeration of the PVF. Typical residence time of the dispersion in a Netzsch mill ranges from thirty seconds up to ten minutes.

For some applications, it may be desirable to incorporate nacreous pigments in the dispersion. By nacreous pigment is meant mica particles, and mica particles coated with pigment. Nacreous pigment is also known as pearlescent pigment. Such particles give a lustrous appearance to the films in which they are incorporated.

The nacreous pigment dispersion is typically prepared by mixing the nacreous pigment with a polyvinyl fluoride/propylene carbonate mixture using a propeller, spatula, or other low energy intensive mixing device. Optionally, solid color pigments which have been previously dispersed using dense agitated medium such as sand, steel shot, or pebbles as in a ball mill, an attritor, or a Netzsch mill can be added to the nacreous pigment/polyvinyl fluoride/propylene carbonate mixture. Pigments that can be used in combination with the pearlescent pigments include such pigments as titanium dioxide, carbon black, copper pthalocyanine, quinacridone, perylene, iron oxide, mixtures thereof, among others.

The concentration of PVF in the dispersion will vary with the particular polymer and the process equipment and the conditions used. In general, the fluoropolymer will comprise from about 30 to about 45% by weight of the dispersion.

Films of polyvinyl fluoride may be formed by extrusion procedures such as those described in U.S. Pat. Nos. 3,139,470 and 2,953,818. These patents describe the feeding of polyvinyl fluoride dispersion to a heated extruder that is connected to a slotted casting hopper. A tough coalesced extrudate of polyvinyl fluoride is extruded continuously in the form of a film containing latent solvent. The film can be merely dried or, alternately, can be heated and stretched in one or more directions while the solvent is volatilized from the film. When stretching is used, oriented film is produced. Alternatively, films of polyvinyl fluoride can be cast from dilute dispersions of the polymer in latent solvent and unoriented films are produced.

In fluoropolymer film casting processes, the fluoropolymer is formed into its desired configuration by casting the dispersion onto a support, by using any suitable conventional means, such as spray, roll, knife, curtain, gravure coaters, or any other method that permits applying a substantially uniform film without streaks or other defects. The thickness of the cast dispersion is not critical, so long as the resulting film has sufficient thickness to be self-supporting and be satisfactorily removed from the substrate onto which the dispersion is cast. In general, a thickness of at least about 0.25 mil (6.4 μm) is satisfactory, and thicknesses of up to about 15 mils (381 μm) can be made by using the dispersion casting techniques of the present invention. A wide variety of supports can be used for casting films according to the present invention, depending on the particular polymer and the coalescing conditions. The surface onto which the dispersion is cast should be selected to provide easy removal of the finished film after it is coalesced. While any suitable support can be employed for casting the fluoropolymer dispersion, examples of suitable supports include polymeric films or steel belts.

After casting the fluoropolymer dispersion onto the support, the fluoropolymer is then heated to coalesce the fluoropolymer into a film. The conditions used to coalesce the polymer will vary with the polymer used, the thickness of the cast dispersion, among other operating conditions. Typically, when employing a PVF dispersion, oven temperatures of from about 340° F. (171° C.) to about 480° F. (249° C.) can be used to coalesce the film, and temperatures of about 380° F. (193° C.) to about 450° F. (232° C.) have been found to be particularly satisfactory. The oven temperatures, of course, are not representative of the temperatures of the polymer being treated, which will be lower. After coalescence, the finished film is stripped from the support by using any suitable conventional technique.

The discontinuous top layer of fluoropolymer is prepared in substantially the same ways as described for the base layer with the added step that for the top layer, the fluoropolymer film is chopped after forming to produce flakes of polymer film. Typical of the equipment used to produce polymer flake is a 12 inch (30 cm) Rotary Knife Cutter manufactured by Sprout, Waldron & Co. Inc. of Muncy, Pa. The flake size can vary greatly, from a speck of polymer film to something more substantial. The thickness is the same as the film from which it is produced. The longest linear dimension of the flake is typically in the range of 1 mil (0.0254 mm) to 1 inch (25.4 mm). The flakes are adhered to the fluoropolymer base layer in a manner that will be described below.

The fluoropolymer top layer may be of the same or different fluoropolymer composition as the base film. The fluoropolymer top layer may have the same color as the base film in which case a textured, decorative surface is formed after the flakes are adhered to the base layer. The term “color” also refers to shade. By “shade” it is meant a color that is only slightly different than the one under consideration. By “texture” or “textured” it is meant a tactilely distinct surface structure or pattern that creates a nonplanar surface.

The texture of the decorative surface sheeting varies greatly depending on flake dimension, density of flakes, pattern of flakes, retained solvent in the film and the amount of heat and pressure used during application. In some cases, flakes are only lightly pressed onto the base film surface and in other cases, higher pressures and/or temperatures result in the flakes being partially embedded in the base film. At higher temperatures with minimal pressure, flaked film tends to shrink providing curled up edges that add to surface roughness. Surface roughness can also vary with the color of the flake. Certain films retain more solvent than others, leading to the application of softer, more malleable flake that yields a somewhat smoother surface texture.

Surface roughness of sheeting and panels of this invention are measured using a Pocket Surf III profilometer, manufactured by Mahr Federal, Inc of Providence R.I. The roughness varies from 50 to 6000 microinches (1.3 to 150 μm), preferably from 75 to 1000 microinches (1.9 to 25 μm).

The fluoropolymer top layer may in its preferred form have a second color different from the first color of the fluoropolymer base film in which case a surface that is both textured and speckled is formed. Further the discontinuous top layer may be formed of multiple fluoropolymer films each having a different color. The textured, speckled surface, when used to form a roofing panel, can be made to aesthetically resemble traditional asphalt roofing. For example, the fluoropolymer base film could be black or charcoal with bonded fluoropolymer film flakes of gray.

The architectural panel of the present invention has an added advantage over painted metal structures that of being slip resistant. This quality is especially important if the architectural panels are used as roofing panels. The textured, slip resistant surface provides for an element of worker safety during construction of the roof as well as when maintenance or repair is required.

### Process

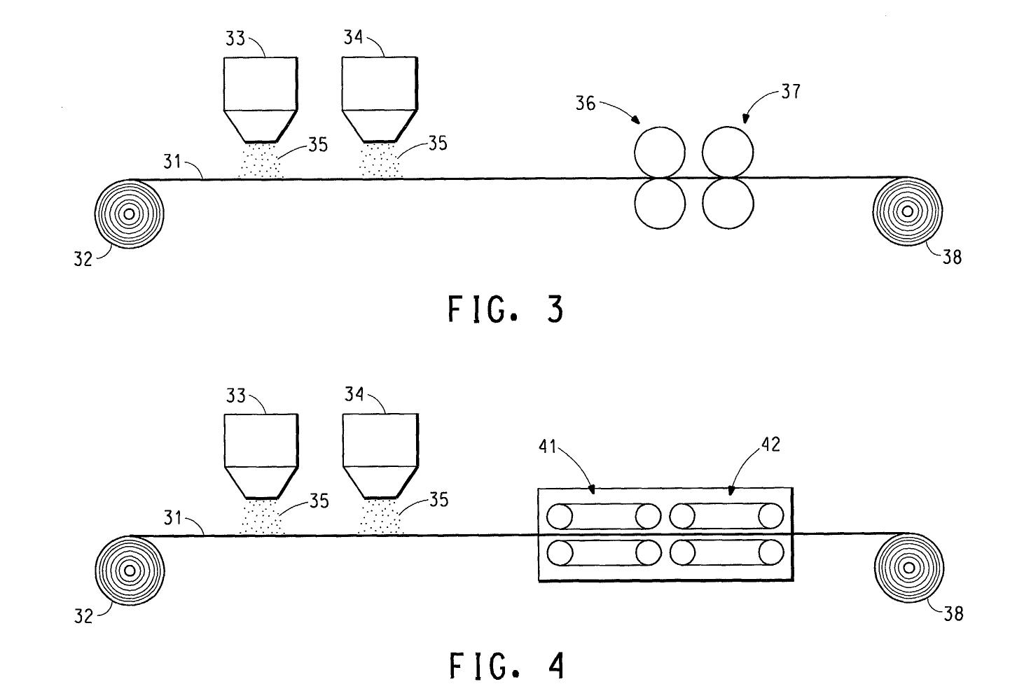

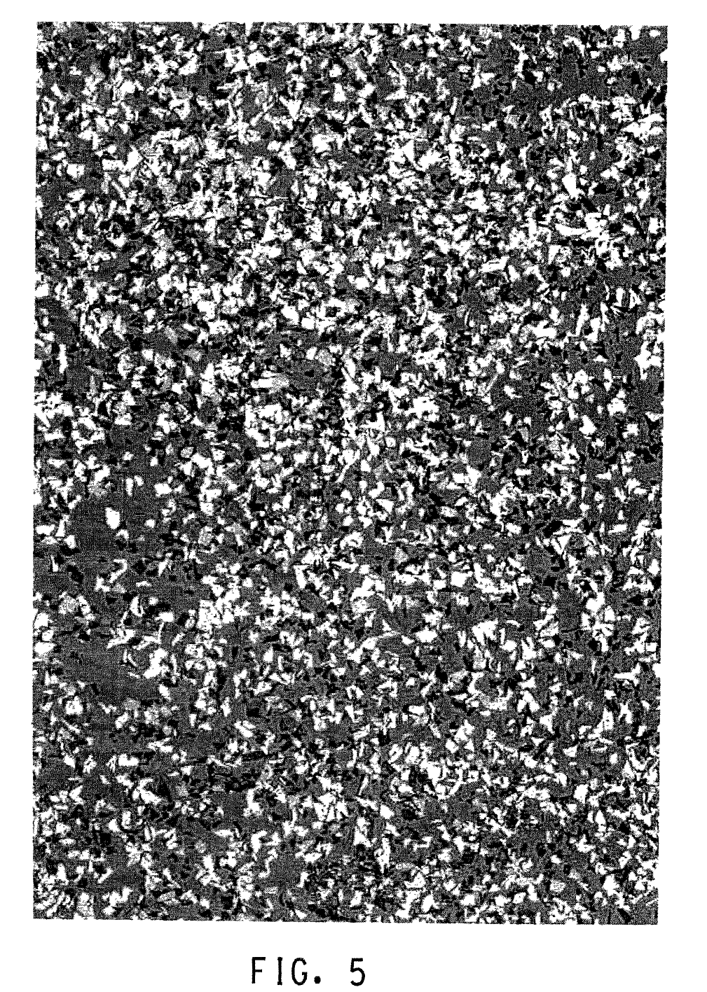

The present invention includes a process for making decorative sheeting for surfacing substrates and for making architectural panels such as roofing panels. FIG. 3 and FIG. 4 illustrate two processes for forming the decorative sheeting for use in surfacing panels. In the schematic of FIG. 3, preformed, continuous length of a base layer 31 of fluoropolymer film is unwound from roll 32. Base layer 31 is passed under flake applicators 33, 34 and a discontinuous top layer of fluoropolymer film in flake form 35 is applied to the base layer. Although shown in this schematic for the purposes of illustration as two applicators applying flakes of two different colors, one or more applicators may be used depending on the effects desired. The “sprinkling” of flakes can be accomplished in several ways. One of those ways is the controlled application by vibrating a stream of flakes over a knife edge. Alternatively, the flakes may be applied by shaking through sieves. Flake density on the surface can vary from near zero to total coverage. Flakes may also be applied by transfer adhesive methods, where flake that is secured temporarily on a sheet is transferred onto the base layer. The base layer with flakes is then subjected to a set of heated nip rolls 36 where heat and pressure are applied to the discontinuous top layer causing the top layer to fuse to the base layer and form a textured decorative surface sheeting with a speckled pattern. For films of PVF, roll temperatures are normally between 400° F. and 450° F. (204-232° C.) with the lower roll being at a temperature of about ˜10° F. less than the upper roll. Film shrinkage is controlled by passing the base layer with flakes through a second set of nip rolls 37 that are cooler than the first set, approximately 200-300° F. (93-150° C.). The decorative sheeting of base fluoropolymer film with fused flakes is then wound on roll 38 for subsequent lamination to a substrate.

An alternative to the use of nip rolls in the preparation of decorative sheeting for surfacing panels is illustrated in FIG. 4. The process is the same as that shown described for FIG. 3 with the exception that heat and pressure for fusing the top layer to the base layer are applied by a double belt press. For example a typical press applicable for use in this invention is a double belt press manufactured by Siempelkamp, GmbH of Krefeld, Germany or an isocoric double belt press supplied by Hymmen, GmbH of Bielfeld, Germany. A double belt press allows for a more controllable bonding process by the extension of the heating and pressure dwell times, dependent on speed and length. Shown in FIG. 4, is a hot zone with heated double belt press 41 having a temperature range of 400-450° F. (204-232° C.) and a cooling zone with double belt press 42 having a lower temperature than press 41, in the range of from ambient to 200° F. (93° C.). In the preferred mode of processing, the temperature in the cooling zone is controlled so as to return the film to room temperature when it exits the press.

The decorative sheeting produced may then be laminated to a metal substrate to form an architectural panel. In a preferred embodiment, the reverse surface (side opposite the flakes) of the fluoropolymer film is surface treated to enhance adherability. In standard manufacturing processes, fluoropolymer film is often surface treated immediately after casting. However, in this embodiment it has been found preferable to first fuse the top layer to the base layer without the films having been surface treated in order to achieve a better heat seal between the two thermoplastic layers. Subsequently, the side of the decorative sheeting to be bonded to the metal substrate is surface treated. Surface treatment can be achieved by exposing the film to a gaseous Lewis acid, to sulfuric acid or to hot sodium hydroxide. Preferably, the surface is treated by exposing the surface to an open flame while cooling the opposite surface. Treatment to enhance adherability can also be achieved by subjecting the film to a high frequency, spark discharge such as corona treatment. Additional treatments such as alkali metal bath treatments or ionizing radiation, e.g., electron beams, may also be useful.

The decorative sheeting is then applied to metal substrates using many common adhesives and various laminating processes. In a typical coil coating process, rolls of decorative surface sheeting are continuously laminated to coils of steel by unwinding bare metal coil such as steel, cleaning/degreasing the metal surface, chemically treating the surfaces to enhance adhesion and provide some corrosion protection, applying a primer composition, applying an adhesive and then laminating the decorative surface sheeting to the coil. Each of the process steps is typically followed by a drying/curing step in which the coil passes through an oven. For the lamination step, the decorative surface sheeting is typically pressed on to the coil by means of a pressurized nip roll as the coil exits an oven after the adhesive is applied and dried. The metal coil surfaced with decorative sheeting is then typically wound up.

Adhesives that are useful in the present invention include various amine functional polymers. The amine functional polymers useful for this invention may include but are not limited to acrylic polymers, polyamides, polyurethanes, polyesters, polyaziridines, and epoxy polymers. One preferred form of the amine functional polymer is an amine functional acrylic copolymer described in U.S. Pat. No. 3,133,854 to Simms.

An alternate method for forming the architectural panels of this invention involves forming a continuous base layer of fluoropolymer film and surface treating the base film to enhance adherability. The base film is then applied to a substrate using an adhesive layer. In one embodiment the metal substrate is a coil of steel. A discontinuous top layer of fluoropolymer film, preferably in flake form is then applied to the base layer that is already adhered to the substrate using heat and pressure. The advantage of a process that uses a laminate of base layer film and substrate is that the film is held rigid and shrinkage is minimized. However, this requires that the selection of materials for the film/substrate laminate be appropriate so that the laminate structure can withstand the fusing temperatures. Another advantage of using a laminate of base film and substrate is that the discontinuous top layer, preferably flakes of film, can be applied and sealed by a stationary platen in a batch type process rather than the continuous process as described above.

Panels produced according to this invention have many architectural applications both for exterior and interior use. The articles of this invention have outstanding weather resistance, abrasion resistance, and solvent resistance. They are resistant to chemicals, dirt, stains, graffiti, and deterioration by the sun's rays. While the above description places particular emphasis upon the application of textured, decorative sheeting of this invention to metal substrates primarily for use as roofing materials, the subject matter is applicable to surfacing other substrates and to a wide array of end-use product applications wherein the properties of fluoropolymer provide enhancement. Examples of the many applications include exterior siding, the outer layer of aircraft decorative laminates, graffiti-resistant coverings for interior or exterior wall paneling and flexible fabrics, use as a UV-resistant protective covering for thermoplastic and thermoset parts (such as bumper fascia and fender skirts) on the exterior of automobiles, trucks, buses and trains.

### TEST METHOD

### Surface Roughness

Surface roughness of sheeting and panels is measured using a Pocket Surf III profilometer, manufactured by Mahr Federal, Inc of Providence, R.I. with an Ra scan over a 5 mm span.

### EXAMPLES

The materials used for the following examples and the abbreviations used are as follows:

### Fluoropolymer Films

PVF-1=Charcoal polyvinyl fluoride film 1.5 mils (38.1 μm) thick, available as TEDLAR® TCC15SL3 from The DuPont Company, Wilmington, Del.

PVF-2=Granite gray polyvinyl fluoride film 1.5 mils (38.1 μm) thick available as TEDLAR® TGY15SL3 from The DuPont Company, Wilmington, Del.

PVF-3=Sable brown polyvinyl fluoride film 1.5 mils (38.1 μm) thick, available as TEDLAR® THB15BL3 from The DuPont Company, Wilmington, Del.

PVF-4=Doeskin polyvinyl fluoride film 1.5 mils (38.1 μm) thick available as TEDLAR® TDS15BL3 from The DuPont Company, Wilmington, Del.

PVF-5=Island ivory polyvinyl fluoride film 1.5 mils (38.1 μm) thick, available as TEDLAR® TCM15SL3 from The DuPont Company, Wilmington, Del.

PVF-6=Shellwhite polyvinyl fluoride film 1.5 mils (38.1 μm) thick, available as TEDLAR® TWH15SL3 from The DuPont Company, Wilmington, Del.

Both surfaces of PVF-4 are flame-treated during manufacture. The surfaces of the other films used in these examples are untreated.

Substrates

Substrate 1=aluminum sheet having a thickness of 23 mils (0.6 mm).

Substrate 2=white polyvinyl chloride sheet having a thickness of 135 mils. (3.4 mm).

### Adhesive

Adhesive=Amine functional acrylic adhesive 68070 available from The DuPont Company, Wilmington, Del.

### Example 1

Decorative sheeting resembling the surface of traditional asphalt shingle is prepared according to this invention.

A preformed, continuous length of charcoal gray polyvinyl fluoride base film (PVF-1) 20″ (51 cm) wide is unwound from a roll and fed through two heated calendar rolls of a three roll, 22-inch face non-wovens laboratory calendar machine manufactured by B. F. Perkins of Rochester, N.Y. a division of Roehlen Industries. Only the two top rolls are used. The bottom roll of the calendar machine is not used. The middle roll is maintained at a temperature of between 350° F. and 390° F. (177-199° C.). The upper roll is heated to a temperature in the range of from 400° F. to 450° F. (199-232° C.). Granite grey polyvinyl fluoride film (PVF-2) is fed to a 12 inch (30 cm) Rotary Knife Cutter manufactured by Sprout, Waldron & Co. Inc. of Muncy, Pa. to form flakes of film of varying sizes. The rotary knife cutter has a screen, manufactured by Harrington and King, with 0.077″ diameter holes, 5/64″ staggered, 7/64″ center 96 holes/square inch, 45% open area. Typical flake size varies with the longest linear dimension being between 1 mil and approximately 3 mm. The flakes of PVF-2 are distributed over the surface of PVF-1 by sprinkling the flake from a perforated plastic container to form a discontinuous top layer of fluoropolymer film on base layer PVF-1. The base layer with flakes is then subjected to the calendar rolls where heat and pressure are applied to the discontinuous top layer causing the top layer to fuse to the base layer and form a textured decorative surface sheeting with a speckled pattern. Some neckdown of the film, attributable to film shrinkage is observed. Shrinkage is controlled by increasing film contact with the lower, cooled roll. Increased contact is achieved by wrapping the film approximately 90° around the cooled roll. The decorative sheeting of base fluoropolymer film with fused flakes is then wound up, ready for application to other surfaces to form architectural panels.

The decorative sheeting of this example closely resembles the surface of traditional asphalt shingle. The surface roughness is in the range of 140-200 microinches (3.5-5 μm).

### Example 2

Decorative sheeting having multiple colors in the top discontinuous layer is prepared according to the teachings of this invention.

The same procedure as described in Example 1 is used to prepare decorative sheeting with the following exceptions. The base layer is a preformed, continuous length of sable brown polyvinyl fluoride film (PVF-3). Two polyvinyl fluoride films, doeskin PVF-4 and ivory island PVF-5 are fed to the rotary knife cutter and flaked. Flakes of PVF-4 and PVF-5 are mixed in the perforated plastic container and sprinkled onto base layer PVF-3. After fusing the film and flake in the heated calendar rolls, textured decorative sheeting with flakes of multiple fluoropolymer films each having a different color is formed. The surface roughness is in the range of 100 and more than 300 microinches (2.5 to >7.6 μm) 300 microinches is the limit of measurement of the profilometer.

### Example 3

Two architectural panels having decorative sheeting with multiple colors in the top discontinuous layer are prepared according to the teachings of this invention.

Decorative sheeting is prepared as described in Example 1 with the following exceptions. The base layer is a preformed, continuous length of doeskin polyvinyl fluoride film (PVF-4). Two polyvinyl fluoride films, shellwhite PVF-6 and charcoal PVF-1 are fed to the rotary knife cutter and flaked. Flakes of PVF-6 and PVF-1 are mixed in the perforated plastic container and sprinkled onto base layer PVF-4. After fusing the film and flake in the heated calendar rolls, textured decorative sheeting with flakes of multiple fluoropolymer films each having a different color is formed.

The decorative sheeting produced is then used to produce two laminated architectural panels. Panel 1 is decorative sheeting laminated to Substrate 1 (aluminum). Panel 2 is decorative sheeting laminated to Substrate 2 polyvinyl chloride). To form Panel 1, adhesive is applied onto the reverse surface (side opposite the flakes) of a piece of decorative sheeting, measuring approximately 24″×13″ (61 cm×33 cm). The coated sheeting is dried in a 150° F. (66° C.) oven. The adhesive coated side of the sheeting is applied to a sheet of degreased and cleaned aluminum, also measuring approximately 24″×13″ (61 cm×33 cm). The sheeting and aluminum composite is placed into a preheated hydraulic press, Model# 150-2424-4TM, manufactured by Wabash Platen Press, of Wabash, Ind. Preheat temperature is 350° F. (177° C.). The press is closed and the aluminum surfaced with decorative sheeting is subjected to 3 tons (2720 kg) of pressure for 3 minutes to cause bonding. The newly formed laminate is cooled under pressure to 125° F. (52° C.) to produce an architectural panel of aluminum surfaced with decorative sheeting.

To form Panel 2, adhesive is applied onto the reverse surface (side opposite the flakes) of a piece of decorative sheeting, measuring approximately 8″×11″ (20 cm×28 cm). The coated sheeting is dried in a 150° F. (66° C.) oven. The adhesive coated side of the sheeting is applied to a sheet of substrate 2 also measuring approximately 8″×11″ (20 cm×28 cm). The sheeting and PVC composite is placed in a hydraulic press (manufactured by Wabash Platen Press, of Wabash, Ind.) that is preheated to 350° F. (177° C.). The press is closed and the PVC sheet surfaced with decorative sheeting is subjected 3 tons (2720 kg) of pressure for 3 minutes to cause bonding. The newly formed laminate is cooled under pressure to 125° F. (52° C.) to produce an architectural panel of PVC surfaced with decorative sheeting.

The surface roughness of the sheeting and the panels is in the range of 110-200 microinches (2.8 to 5.1 μm).

What is claimed is:

1. A decorative architectural panel comprising:
a. a substrate;
b. a base layer of preformed fluoropolymer film adhered to said substrate; and
c. at least one discontinuous top layer of fluoropolymer forming a decorative, textured surface.

2. The panel of claim 1 wherein the base layer of fluoropolymer film is pigmented with a first color or is clear and the discontinuous top layer of fluoropolymer film is pigmented with a second color to form a decorative, textured surface with a speckled pattern.

3. The panel of claim 1 wherein said textured surface forms a slip resistant surface.

4. The panel of claim 1 wherein said discontinuous top layer is comprised of flakes of fluoropolymer film.

5. The panel of claim 4 wherein said discontinuous top layer is comprised of flakes of multiple fluoropolymer films each having a different color.

6. The panel of claim 1 wherein the substrate is metal.

7. The panel of claim 6 wherein the metal substrate is steel.

8. The panel of claim 7 wherein the steel is coated with zinc or zinc aluminum alloy.

9. The panel of claim 6 wherein the metal substrate is aluminum.

10. The panel of claim 6 which forms metal roofing.

11. The panel of claim 6 which forms an exterior wall panel.

12. The panel of claim 6 wherein the total thickness is from 10 mils (250 μm) to 42 mils (1070 μm).

13. The panel of claim 1 wherein the substrate is a polymer.

14. The panel of claim 1 wherein the fluoropolymer is selected from polymers and copolymers of trifluoroethylene, hexafluoropropylene, monochlorotrifluoroethylene, dichlorodifluoroethylene, tetrafluoroethylene, perfluorobutyl ethylene, perfluoro(alkyl vinyl ether), vinylidene fluoride, and vinyl fluoride and blends thereof and blends of said polymers with a nonfluoropolymer.

15. The panel of claim 1 wherein said fluoropolymer is selected from polyvinyl fluoride, ethyleneltetrafluoroethylene copolymer, tetrafluoroethylene/perfluoro(propyl vinyl ether) copolymer.

16. Decorative sheeting for surfacing architectural panels comprising:
a. a pigmented base layer of preformed fluoropolymer film having a first color;
b. at least one discontinuous pigmented top layer of fluoropolymer having a second color adhered to said base layer forming a decorative speckled pattern.

17. Decorative sheeting according to claim 16 wherein the speckled pattern forms a textured surface.

18. Decorative sheeting according to claim 16 wherein the speckled pattern forms a slip resistant surface.

19. Decorative sheeting according to claim 16 wherein the total thickness of the sheeting is from of 0.5 mils (13 micrometers) to 12 mils (305 micrometers).

20. Decorative sheeting for surfacing architectural panels comprising:
a. a base layer of preformed fluoropolymer film; and
b. at least one discontinuous top layer of fluoropolymer forming a decorative, textured surface.

21. Decorative sheeting according to claim 16 wherein said discontinuous top layer is comprised of flakes of fluoropolymer film.

22. A process for making decorative sheeting for surfacing architectural panels comprising:
a. forming a continuous pigmented base layer of fluoropolymer film having a first color;
b. applying at least one discontinuous pigmented top layer of fluoropolymer film having a second color to said base layer; and
c. applying heat and pressure to said top layer causing said top layer to fuse to said base layer and form a decorative sheeting with a speckled pattern.

23. The process of claim 22 wherein said discontinuous top layer is in flake form.

24. The process of claim 22 wherein said step b of applying said discontinuous top layer and said step c of applying heat and pressure to fuse said top layer and said base layer result in decorative sheeting having a textured surface.

25. A process for making architectural panels comprising:
a. forming a continuous base layer of fluoropolymer film;
b. applying at least one discontinuous top layer of fluoropolymer to said base layer;
c. applying heat and pressure to said top layer causing said top layer to fuse to said base layer; and
d. adhering said base layer with said fused discontinuous top layer to a substrate to form a decorative, textured architectural panel.

26. The process of claim 25 wherein said discontinuous top layer is in flake form.

27. A process for making architectural panels of claim 25 wherein said continuous base layer of fluoropolymer film is pigmented having a first color, and said discontinuous top layer is pigmented having a second color.

28. A process for making architectural panels comprising:
a. forming a continuous base layer of fluoropolymer film;
b. adhering said base layer to a substrate to form a laminate structure;
c. applying at least one discontinuous top layer of fluoropolymer to said base layer of said laminate structure; and
d. applying heat and pressure to said laminate structure with said top layer causing said top layer to fuse to said base layer to form a textured, decorative architectural panel.

29. The process of claim 28 wherein said discontinuous top layer is in flake form.
